(19) United States
(12) Patent Application Publication
(10) Pub. No.: US 2019/0244258 A1
(43) Pub. Date: Aug. 8, 2019

(54) SPATIAL AUDIO BASED ADVERTISING IN VIRTUAL OR AUGMENTED REALITY VIDEO STREAMS

(71) Applicant: Livelike Inc., New York, NY (US)

(72) Inventor: Adrian Curiel, Brooklyn, NY (US)

(21) Appl. No.: 16/388,989

(22) Filed: Apr. 19, 2019

Related U.S. Application Data
(63) Continuation of application No. PCT/US17/58827, filed on Oct. 27, 2017.
(60) Provisional application No. 62/413,747, filed on Oct. 27, 2016.

(51) Int. Cl. G06Q 30/02; G06F 3/01

(52) U.S. Cl. CPC G06Q 30/0277; G06T 19/006; G06F 3/013; G06F 3/012

(57) ABSTRACT

Spatial audio-based advertising in VR video streams is provided. In various embodiments, a spatial audio cue is played to a user. The spatial audio cue has an apparent position in a virtual environment. The user's field of view is tracked towards the apparent position of the audio cue. Sponsored content is displayed to the user at about the apparent position of the audio cue.

### CROSS-REFERENCE TO RELATED APPLICATIONS

This application is a continuation of International Application No. PCT/US17/58827, filed Oct. 27, 2017, which claims the benefit of U.S. Provisional Application No. 62/413,747, filed Oct. 27, 2016, which are hereby incorporated by reference in their entireties.

### BACKGROUND

Embodiments of the present invention relate to virtual reality presentations, and more specifically, to spatial audio-based advertising in virtual or augmented reality video streams.

### BRIEF SUMMARY

According to embodiments of the present disclosure, methods of and computer program products for audio-based advertising are provided. A spatial audio cue is played to a user. The spatial audio cue has an apparent position in a virtual environment. The user's field of view is tracked towards the apparent position of the audio cue. Sponsored content is displayed to the user at about the apparent position of the audio cue.

In some embodiments, the field of view is determined by tracking eye motions of the user. In some embodiments, the field of view is determined by tracking head motions of the user. In some embodiments, the field of view is determined by tracking motions of a handheld device.

In some embodiments, the sponsored content comprises a virtual object in the virtual environment. In some such embodiments, user interaction with the virtual object is detected and additional sponsored content is presented to the user.

### BRIEF DESCRIPTION OF THE SEVERAL VIEWS OF THE DRAWINGS

FIG. 1 illustrates processes for user interaction with spatial audio-based advertising systems according to the present disclosure.

FIG. 2 illustrates a method for spatial audio-based advertising according to embodiments of the present disclosure.

FIG. 3 depicts a computing node according to an embodiment of the present invention.

### DETAILED DESCRIPTION

In an immersive environment, a user is not necessarily aware of the presence of content outside of their field of view. This poses a particular challenge for advertising. While an advertiser may have placed content within a virtual reality (VR) or augmented reality (AR) environment, the interactivity of the VR or AR environment may result in a user inadvertently avoiding sponsored content. A user is in a VR experience doesn't necessarily know that sponsored content is located throughout the experience because it is out of sight. Accordingly, the present disclosure provides for spatial audio cues that inform and guide the user to sponsored content.

According to various embodiments of the present disclosure, spatial audio is provided to lead the user to sponsored content placed throughout a VR experience. Interactive advertisements are customized presentations developed and imbedded within the body of VR content. Users can interact with forms of 3D objects and augmented reality animations within of the VR experience.

In various embodiments, augmented graphic animations are provided that appear within the VR environment. In this way, sponsored content and 3D objects that render sponsored content may be displayed when the user looks in their direction in a VR experience. For example, a product placement may be included directly in a 3D scene, for example a branded cola can. Video screens may also be included in a VR environment, which display sponsored content when a user is nearby or directs their gaze to the screens. More complex sponsored object placements are available as well, for example dynamic addition of branded decals to existing objects in the VR scene (e.g., to display a logo on a passing car).

In various embodiments, a user of a VR or AR system may indicate the sponsored content or types of sponsored content that they are interested in. A user may also initiate an interaction with sponsored content to be directed to additional sponsored content within the VR experience or that directs them outside of the VR environment to a sponsor's platform of choice.

In this way, spatial audio, interactive 3D objects and augmented reality graphics are merged to create a new form of advertising within a VR experience.

It will be appreciated that a variety of virtual and augmented reality devices are known in the art. For example, various head-mounted displays providing either immersive video or video overlays are provided by various vendors. Some such devices integrate a smart phone within a headset, the smart phone providing computing and wireless communication resources for each virtual or augmented reality application. Some such devices connect via wired or wireless connection to an external computing node such as a personal computer. Yet other devices may include an integrated computing node, providing some or all of the computing and connectivity required for a given application.

Virtual or augmented reality displays may be coupled with a variety of motion sensors in order to track a user's motion within a virtual environment. Such motion tracking may be used to navigate within a virtual environment, to manipulate a user's avatar in the virtual environment, or to interact with other objects in the virtual environment. In some devices that integrate a smartphone, head tracking may be provided by sensors integrated in the smartphone, such as an orientation sensor, gyroscope, accelerometer, or geomagnetic field sensor. Sensors may be integrated in a headset, or may be held by a user, or attached to various body parts to provide detailed information on user positioning.

It will also be appreciated that various embodiment are application to virtual and augmented reality environments in general, including those that are presented without a headset. For example, a magic window implementation of VR or AR uses the display on a handheld device such as a phone as a window into a virtual space. By moving the handheld, by swiping, or by otherwise interacting with the handheld device, the user shifts the field of view of the screen within the virtual environment. A center of a user's field of view can be determined based on the orientation of the virtual window within the virtual space without the need for eye-tracking. However, in devices including eye-tracking, more precision may be obtained.

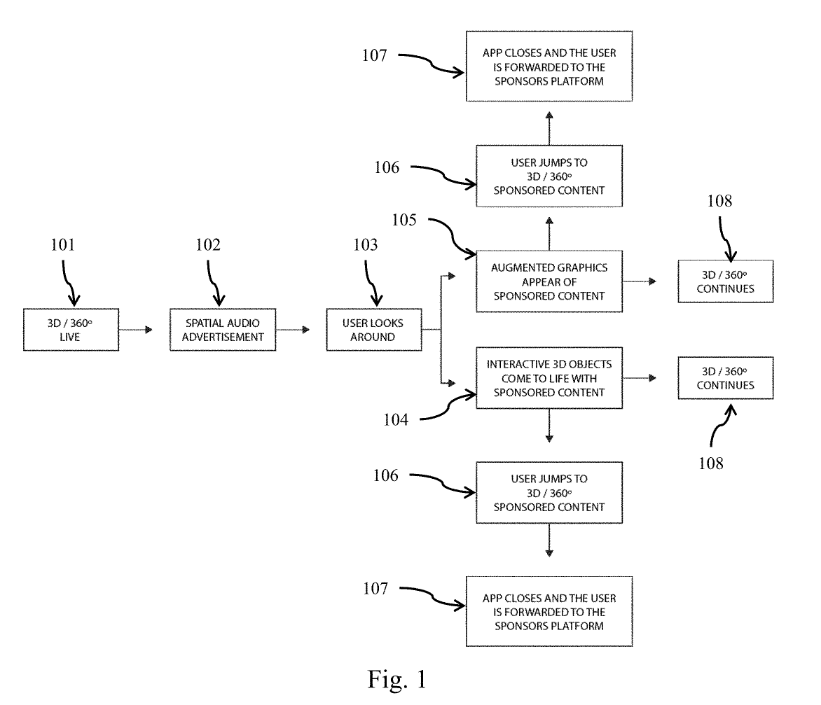

With reference now to FIG. 1, exemplary user interaction with spatial audio-based advertising systems is illustrated according to embodiments of the present disclosure. A 3D or 360° video feed 101 is provided. Embedded within the video feed is a spatial audio component 102. In some embodiments, the audio component includes an audible cue indicative of the presence of sponsored content such as an advertisement within the VR or AR environment. The audio component is spatially oriented within the VR or AR environment to seem to originate from the direction of sponsored content. When a user looks around 103, directing their attention in the direction of the sponsored content, an interactive object in the VR environment may be activated 104 or augmented graphics may appear 105. The user may continue the VR or AR experience, 108, or may jump to that sponsored content 106 within the VR or AR environment. On user interaction with the sponsored content, they may be forwarded to a sponsor's platform 107.

For example, positional audio of a cola can opening may direct a user's attention to a cola can placed in the VR environment as a sponsored object. When it reaches the user's center of view, the can may open. If the user activates the can, additional sponsored content may play, or they may be relocated in the virtual environment to a sponsored location. In addition to presentation of sponsored content within the virtual environment, further interaction may direct a user to content outside the virtual environment, such as a sponsored website.

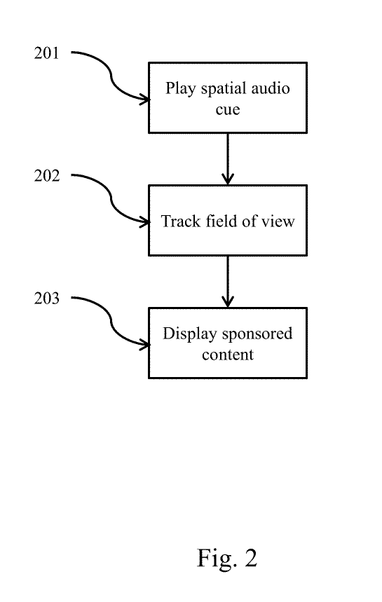

With reference now to FIG. 2, a method for spatial audio-based advertising according to embodiments of the present disclosure is illustrated. At 201, a spatial audio cue is played to a user. The spatial audio cue has an apparent position in a virtual environment. At 202, the user's field of view is tracked towards the apparent position of the audio cue. At 203, sponsored content is displayed to the user at about the apparent position of the audio cue.

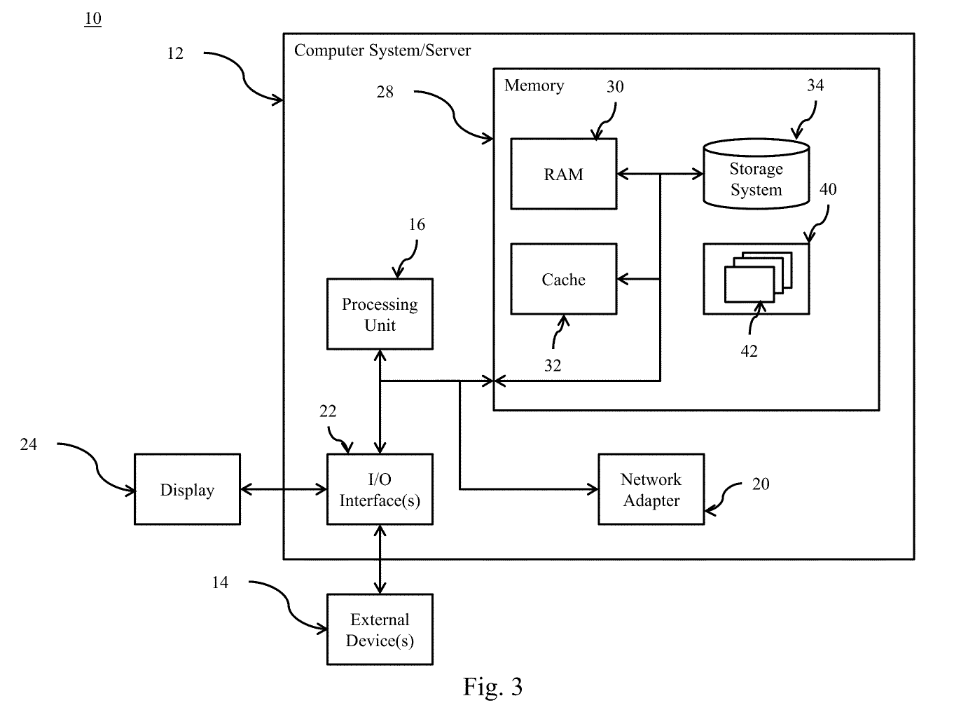

Referring now to FIG. 3, a schematic of an example of a computing node is shown. Cloud computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
playing a spatial audio cue to a user, the spatial audio cue having an apparent position in a virtual environment;
tracking a field of view of the user towards the apparent position of the audio cue;
displaying sponsored content to the user in the virtual environment at about the apparent position of the audio cue.

2. The method of claim 1, wherein the field of view is determined by tracking eye motions of the user.

3. The method of claim 1, wherein the field of view is determined by tracking head motions of the user.

4. The method of claim 1, wherein the field of view is determined by tracking motions of a handheld device.

5. The method of claim 1, wherein the sponsored content comprises a virtual object in the virtual environment.

6. The method of claim 5, further comprising:
detecting user interaction with the virtual object;
presenting additional sponsored content to the user.

7. A computer program product for spatial audio-based advertising, the computer program product comprising a computer readable storage medium having program instructions embodied therewith, the program instructions executable by a processor to cause the processor to perform a method comprising:
playing a spatial audio cue to a user, the spatial audio cue having an apparent position in a virtual environment
tracking the user's field of view towards the apparent position of the audio cue;
displaying sponsored content to the user in the virtual environment at about the apparent position of the audio cue.

8. The computer program product of claim 7, wherein the field of view is determined by tracking eye motions of the user.

9. The computer program product of claim 7, wherein the field of view is determined by tracking head motions of the user.

10. The computer program product of claim 7, wherein the field of view is determined by tracking motions of a handheld device.

11. The computer program product of claim 7, wherein the sponsored content comprises a virtual object in the virtual environment.

12. The computer program product of claim 11, the method further comprising:
detecting user interaction with the virtual object;
presenting additional sponsored content to the user.

13. A system comprising:
a computing node comprising a computer readable storage medium having program instructions embodied therewith, the program instructions executable by a processor of the computing node to cause the processor to perform a method comprising:
playing a spatial audio cue to a user, the spatial audio cue having an apparent position in a virtual environment
tracking the user's field of view towards the apparent position of the audio cue;
displaying sponsored content to the user in the virtual environment at about the apparent position of the audio cue.

14. The system of claim 13, wherein the field of view is determined by tracking eye motions of the user.

15. The system of claim 13, wherein the field of view is determined by tracking head motions of the user.

16. The system of claim 13, wherein the field of view is determined by tracking motions of a handheld device.

17. The system of claim 13, wherein the sponsored content comprises a virtual object in the virtual environment.

18. The system of claim 17, the method further comprising:
detecting user interaction with the virtual object;
presenting additional sponsored content to the user.
